(19) United States
(12) Patent Application Publication
(10) Pub. No.: US 2008/0023926 A1
(43) Pub. Date: Jan. 31, 2008

(54) Chuck assembly and method for controlling a temperature of a chuck

(76) Inventor: Young-Han Kim, Seoul (KR)

Correspondence Address: LEE & MORSE, P.C., 3141 FAIRVIEW PARK DRIVE, SUITE 500, FALLS CHURCH, VA, 22042, US

(21) Appl. No.: 11/826,313

(22) Filed: Jul. 13, 2007

(30) Foreign Application Priority Data
Jul. 25, 2006 (KR) 2006-70023

(51) Int. Cl. B23B 5/22; B23P 15/26

(52) U.S. Cl. 279/126; 165/253

(57) ABSTRACT

Exemplary embodiments relate to a chuck assembly. The chuck assembly may include a chuck having a first channel having a fluid circulating therein, and a temperature control system adapted to maintain a temperature of the fluid within a first temperature range and vary the maintained temperature range of the fluid to a second temperature range from the first temperature range.

### BACKGROUND OF THE INVENTION

1. Field of the Invention

Exemplary embodiments are related to a chuck assembly and a method of controlling a temperature of a chuck.

2. Description of the Related Art

In manufacturing of semiconductor devices, various types of chucks, e.g., mechanical clamps or vacuum chucks, may be used to hold wafers. However, one of the limitations in mechanical clamps and vacuum chucks may be that these types of chucks serve only one function, e.g., merely used to hold wafers. Accordingly, electrostatic chucks have been increasingly employed, since electrostatic chucks may provide uniform heat treatment while the wafer is closely adhered and may minimize the production of particles. Moreover, electrostatic chucks, particularly for semiconductor apparatuses, may remove wafers without coming in contact with the wafers by using an electrostatic force.

However, in the conventional chuck assembly, a temperature may be controlled by only a single temperature control system, e.g., the temperature control may be to merely maintain a constant temperature. Accordingly, the conventional chuck assembly may not be able to quickly control the temperature required in each step of a semiconductor manufacturing process.

### SUMMARY OF THE INVENTION

Exemplary embodiments are therefore directed to a chuck assembly, and a method for, which substantially overcome one or more of the problems due to the limitations and disadvantages of the related art.

It is therefore a feature of exemplary embodiments to provide a chuck assembly for supporting a wafer which may be quickly controlled to various temperatures during a semiconductor manufacturing process.

It is therefore another feature of exemplary embodiments to provide a chuck assembly to enhance operating efficiency of a semiconductor device having a chuck.

At least one of the above and other features of exemplary embodiments may provide a chuck assembly including a chuck having a first channel with a fluid circulating therein, and a temperature control system adapted to maintain a temperature of the fluid within a first temperature range and vary the maintained temperature range of the fluid to a second temperature range from the first temperature range.

At least one of the above and other features of exemplary embodiments may provide a method for controlling the temperature of a chuck. The method may include setting a temperature of a fluid within a first temperature range, varying the temperature of the fluid to a second temperature range, which may be different than the first temperature range, before the fluid is supplied to a chuck, and supplying the fluid within the second temperature range to the chuck.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a cross-sectional view of a chuck assembly according to an exemplary embodiment;

FIGS. 2 to 4 illustrate graphs of a temperature control in the chuck assembly according to exemplary embodiments; and

FIG. 5 illustrates a cross-sectional view of a chuck assembly according to another exemplary embodiment.

### DETAILED DESCRIPTION OF THE INVENTION

Korean Patent Application 2006-70023 filed on Jul. 25, 2006, in the Korean Intellectual Property Office, and entitled: “Chuck Assembly and Method for Controlling Temperature of Chuck,” is incorporated by reference herein in its entirety.

Exemplary embodiments will now be described more fully hereinafter with reference to the accompanying drawings. The invention may, however, be embodied in different forms and should not be construed as limited to the embodiments set forth herein. Rather, these exemplary embodiments are provided so that this disclosure will be thorough and complete, and will fully convey the scope of the invention to those skilled in the art.

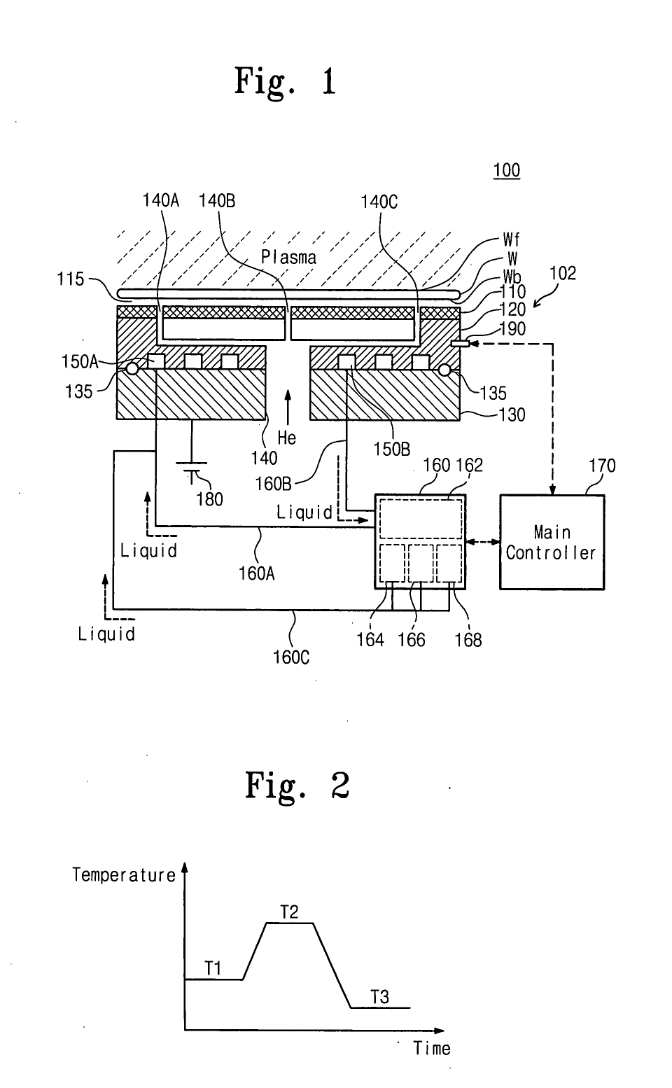

FIG. 1 illustrates a chuck assembly 100 according to exemplary embodiments. The chuck assembly 100, i.e., electrostatic chuck assembly, may electrostatically adsorb a wafer W and may introduce a thermally conductive fluid, e.g., thermoconductive gas to a back surface Wb of the wafer W. Thus, the wafer W may be heated or cooled so to achieve a uniform temperature distribution.

Although this exemplary embodiment describes the introduction of gas to heat or cool the wafer W, one skilled in the art would appreciate that other form of fluid, such as, liquid, may be employed to heat or cool the wafer W.

The chuck assembly 100 may include a chuck 102. The chuck 102 may include an electrode cap 120 and an electrode 130, which may each be made of a metal, for example. The electrode cap 120 may have a top portion including a dielectric film 110, and the electrode 130 may receive a DC voltage, for example, from a power source 180.

A central channel 140 and channels 140A, 140B, and 140C may be formed such that thermoconductive gas may be supplied to the back surface Wb of the wafer W to control the temperature of the wafer W. The thermoconductive gas may be an inert gas, such as, but not limited to, a helium (He) and/or an argon (Ar). It should be appreciated that other types of gases and/or fluids may be employed. The control of temperature of the wafer W may be required, e.g., when plasma is generated on a front surface Wf of the wafer W because the temperature of the wafer W may reach a high temperature due to the bombardment of cations in the plasma, which may break (or crack) a thin film coated on the front surface Wf of the wafer W. This may result in a temperature difference occurring on the wafer W, and thus, produce non-uniform plasma treatment.

The thermoconductive gas may flow to the channels 140A, 140B, and 140C, which may extend to the back surface Wb of the wafer W through the dielectric film 110, after passing through the central channel 140. The thermoconductive gas supplied to the back surface Wb of the wafer W through the channels 140A, 140B, and 140C may uniformly fill a space 115 between the dielectric film 110 and the back surface Wb of the wafer W. Due to the thermoconductive gas uniformly filling the space 115, the temperature of the wafer W may be set to a specific temperature without incurring any local temperature difference.

Channels 150A and 150B may be formed at the chuck assembly 100 to provide a circulation passage of fluid for actively controlling the temperature of the electrode cap 120, and thus, control the temperature of the wafer W. In an exemplary embodiment, the fluid may be a liquid. The liquid may flow into the channel 1 50A and may be drained from the channel 1 50B after circulating in the electrode cap 120. It should be appreciated that the flow of fluid may be reversed, e.g., liquid may flow into the channel 1 50B and may be drained from the channel 150A. The liquid may be selected from at least one of a water, an ethylene glycol, a silicon oil, a liquid Teflon, and a water-glycol mixture. The liquid may be suitable for transferring heat to the electrode cap 120 so as to elevate or drop (or reduce) the temperature of the electrode cap 120. An O-ring 135 may be provided between the electrode cap 120 and the electrode 130 to prevent and/or reduce the leakage of fluid, e.g., liquid and/or thermoconductive gas.

The liquid drained from the channel 150B may flow into a temperature control system 160 through a recovery line 160B. In the temperature control system 160, the liquid may be controlled to have a certain temperature. Afterwards, the liquid may flow into the channel 150A through a main supply line 160A. While the liquid flowing into the channel 150A circulates inside the electrode cap 120, the temperature of the liquid may be maintained at a set temperature so as to enable the temperature of the wafer W to be maintained at a specific temperature. The temperature of the electrode cap 120 may be monitored by a temperature sensor 190. It should be appreciated that the temperature sensor 190 may monitor the temperature in real-time. A main controller 170 may receive information on the temperature of the electrode cap 120 from the temperature sensor 190, and may enable the temperature control system 160 to control the temperature of the liquid based on the information. One skilled in the art should appreciate that the main controller 170 may also control other elements and/or devices in the chuck assembly.

The temperature control system 160 may include a first temperature controller 162 configured to control the temperature of liquid. The first temperature controller 162 may control the temperature of the liquid within a first temperature range, but may not react quickly to temperature variations due to the first temperature controller 162 returning to an initial setting state so as to control the temperature of the liquid within second and third temperature ranges beyond the first temperature range. Thus, the temperature control system 160 may further include a second temperature control system having a plurality of temperature controllers 164, 166 and 168 configured to quickly respond to temperature variation of the liquid within various temperature ranges beyond the first temperature range.

The first temperature controller 162 may be formed together with the second temperature controllers, e.g., enclosed in the same housing (as illustrated in FIG. 1). In an alternative embodiment, the first temperature controller 162 and the second temperature controllers may be independently and separately formed and/or housed (as illustrated in FIG. 1).

In an exemplary embodiment, the first temperature controller 162 may control the temperature of the liquid to a first temperature; a second temperature controller 164 may control the temperature of the liquid to a second temperature, which may be higher than the first temperature; a third temperature controller 166 may control the temperature of the liquid to a third temperature, which may be higher than the second temperature; and a fourth temperature controller 168 may control the temperature of the liquid to a fourth temperature, which may be lower than the first temperature. The temperature control system 160 may be designed to enable the liquid to travel between the temperature controllers 162 through 168.

Further, before the liquid flows into the channel 150A through the main supply line 160A, which may be controlled to the first temperature by the first temperature controller 162, the second temperature controller 164 may separately control the liquid to a specific temperature so as to enable the liquid to flow in a sub-supply line 160C. Accordingly, the liquid flowing in the sub-supply line 160C (and set to a specific temperature) may be mixed with the liquid of the first temperature supplied in the main supply line 160A. Thus, the liquid set to the second temperature, which may be higher than the first temperature due to the mixture with the liquid of the specific temperature, may flow into the electrode cap 120 to be circulated therein. As a result, the temperature of the wafer W may be quickly elevated from the first temperature to the second temperature. The main controller 170 may control the operation of the temperature control system 160 (e.g., temperature controllers 162-168) so as to control flow speed and/or rate of the liquid supplied to the channel 150A. Thus, the temperature of the liquid supplied to the channel 150A may be set to the second temperature. The liquid circulating in the electrode cap 120 may be drained through the channel 150B and recovered to the temperature control system 160 through the recovery line 160B.

Similarly, to elevate the temperature of the wafer W to the third temperature from the second temperature, the liquid may be set to a specific temperature by the third temperature controller 166. The liquid from the third temperature controller 166 of the specific temperature may flow in the sub-supply line 160C. The liquid flowing in the sub-supply line 160C may be mixed with the liquid of the second temperature so that the liquid may be set to the third temperature. The liquid set to the third temperature may flow into the channel 150A to quickly elevate the temperature of the wafer W to the third temperature from the second temperature. Conversely, for dropping the temperature of the wafer W to the fourth temperature from the third temperature, similar operation as discussed above may be performed.

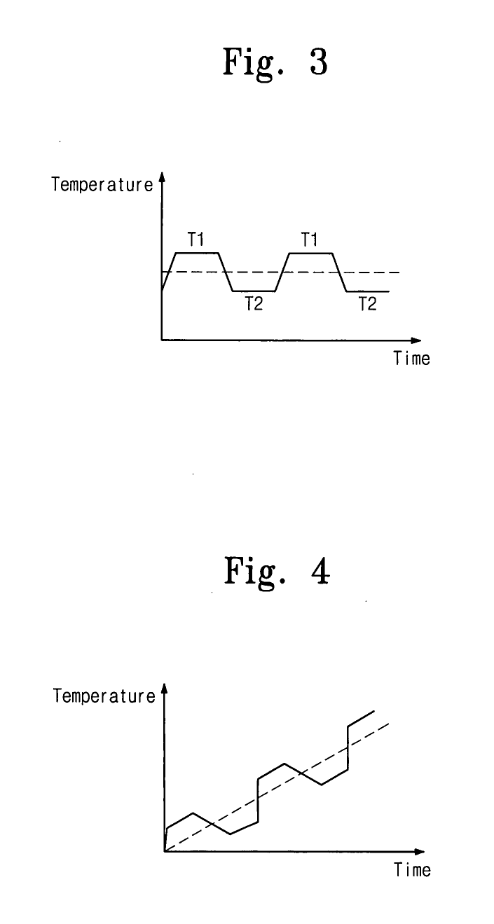

FIGS. 2 through 4 illustrate graphs of a temperature control in the chuck assembly 100, as illustrated in FIG. 1.

Referring to FIG. 2, the graph illustrates process temperatures T1, T2, and T3 during an etching and/or depositing of a plurality of thin films. The graph of FIG. 2 illustrates a temperature profile having the process temperatures T1, T2 and T3 with quick varying responses when the temperatures are different from each other.

Referring to FIG. 3, the graph illustrates a thermal disturbance state during a plasma treatment. The thermal disturbance state may be a state in which the higher temperature T1 and the lower temperature T2 may alternately repeat overtime.

Referring to FIG. 4, the graph illustrates a thermal disturbance environment during a plasma treatment. The thermal disturbance environment may be established while a temperature increases over time during the plasma treatment.

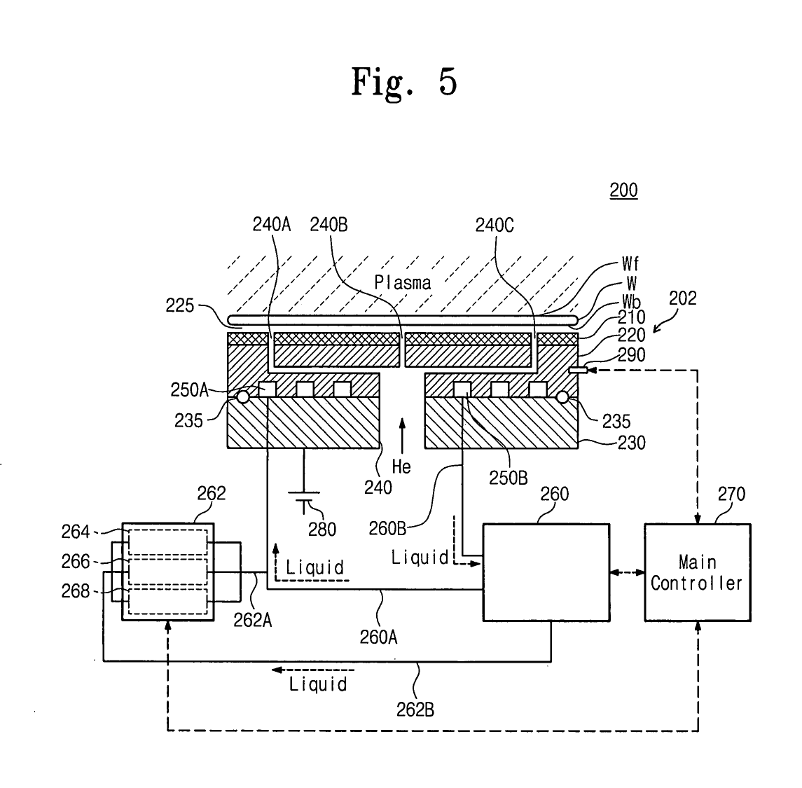

FIG. 5 illustrates a cross-sectional view of a chuck assembly 200 according to another exemplary embodiment. The chuck assembly 200, e.g., an electrostatic chuck assembly, may have a similar configuration as the chuck assembly 100 in FIG. 1.

Referring to FIG. 5, the chuck assembly 200 may include a chuck 202. The chuck 202 may include an electrode cap 220 and an electrode 230. The electrode cap 220 may have a top portion including a dielectric film 210, and the electrode 230 may receive a DC voltage, for example, from a power source 280. An O-ring 235 may be interposed between the electrode cap 220 and the electrode 230 to suppress the leakage of fluid, e.g., a liquid and/or a thermoconductive gas.

As similarly discussed above, in order to reduce the temperature of the wafer W that may be elevated to a higher temperature due to the plasma generated on the front surface Wf of the wafer W, a central channel 240 and channels 240A, 240B, and 240C may be formed to supply thermoconductive gas, e.g., a helium (He) and/or an argon (Ar), to the back surface Wb of the wafer W. In other words, the thermoconductive gas may pass through the central channel 240 and may be supplied to the wafer back surface Wb of the wafer W through the channels 240A, 240B, and 240C, and uniformly distributed in space 225.

Channels 250A and 250B may be formed at the chuck assembly 200 to provide a circulation passage of fluid, e.g., liquid, for cooling or heating the electrode cap 220. The liquid flowing in through the channel 250A may be drained through the channel 250B after circulating in the electrode cap 220. It should be appreciated that the flow of fluid may be reversed, e.g., liquid may flow into the channel 250B and may be drained from the channel 250A. The liquid drained from the channel 250B may flow along a recovery line 260B before being recovered to a first temperature control system 260. The first temperature control system 260 may control the temperature of the recovered liquid and may supply the temperature-controlled liquid to the channel 250A through a supply line 260A. The liquid temperature control of the first temperature control system 260 may be controlled by a main controller 270. The main controller 270 may receive temperature information from a temperature sensor 290, which may be configured to monitor the temperature of the electrode cap 220. One skilled in the art should appreciate that the main controller 270 may also control other elements and/or devices in the chuck assembly.

A second temperature control system 262 may be further connected to the chuck assembly 200 to quickly vary the controlled temperature of the liquid to a higher temperature or a lower temperature. The second temperature control system 262 may include a plurality of temperature controllers 264, 266, and 268 configured to control the temperature of the liquid within different temperature ranges. The second temperature control system 262 may be designed to enable the liquid to travel between the temperature controllers 264 through 268.

The liquid, controlled to a first temperature in the first temperature control system 260, may be controlled to a specific temperature. The liquid may further be controlled before being supplied to the channel 250A through the supply line 260A, by mixing with the liquid flowing into the supply line 260A through a supply line 262A. Thus, the liquid may be set to a second temperature higher than the first temperature. The liquid set to the second temperature may flow into the channel 250A to circulate in the electrode cap 220, so that the temperature of the wafer W may be quickly elevated to the second temperature from the first temperature. The circulating liquid may be drained from the channel 250B to be recovered to the first temperature control system 260 through a recovery line 260B. Moreover, a part of the liquid recovered by the first temperature control system 260 may be recovered to the second temperature control system 262 through the recovery line 262B. The liquid recovery may be equally (or severally) applied to both of the controllers 266 and 268.

Exemplary embodiments may provide the temperature of the wafer may be quickly, actively controlled to various temperatures during the semiconductor manufacturing process to enhance operating efficiency of the semiconductor device with the chuck.

In the figures, the dimensions of elements and regions may be exaggerated for clarity of illustration. It will also be understood that when an element is referred to as being “on”, “connected to” or “coupled to” another element it can be directly on, connected or coupled to the other element or intervening elements may be present. In contrast, when an element is referred to as being “directly on,” “directly connected to” or “directly coupled to” another element, there are no intervening elements present. Further, it will be understood that when an element is referred to as being “under” or “above” another element, it can be directly under or directly above, and one or more elements may also be present. In addition, it will also be understood that when an element is referred to as being “between” two elements, it can be the only element between the two elements, or one or more intervening element may also be present. Like numbers refer to like elements throughout. As used herein, the term “and/or” includes any and all combinations of one or more of the associated listed items.

It will also be understood that, although the terms “first”, “second”, “third” etc. may be used herein to describe various elements, structures, components, regions, layers and/or sections, these elements, structures, components, regions, layers and/or sections should not be limited by these terms. These terms are only used to distinguish one element, structure, component, region, layer and/or section from another element, structure, component, region, layer and/or section. Thus, a first element, structure, component, region, layer or section discussed below could be termed a second element, structure, component, region, layer or section without departing from the teachings of exemplary embodiments.

Spatially relative terms, such as “beneath,” “below,” “lower,” “above,” “upper” and the like, may be used herein for ease of description to describe one element or feature relationship to another element(s) or feature(s) as illustrated in the figures. It will be understood that the spatially relative terms are intended to encompass different orientations of the device in use or operation in addition to the orientation depicted in the figures. For example, if the device in the figures is turned over (or upside down), elements or features described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A chuck assembly, comprising:
a chuck including a first channel having a fluid circulating therein; and
a temperature control system adapted to maintain a temperature of the fluid within a first temperature range and adapted to vary the maintained temperature range of the fluid to a second temperature range from the first temperature range.

2. The chuck assembly as claimed in claim 1, wherein the temperature control system comprises:
a first temperature controller adapted to maintain the fluid within the first temperature range and supply the fluid maintained within the first temperature range to the first channel; and
a second temperature controller having a plurality of temperature controllers adapted to vary the fluid maintained within the first temperature range to the second temperature range before the fluid is supplied to the first channel.

3. The chuck assembly as claimed in claim 2, wherein the first temperature controller and the second temperature controller are formed together.

4. The chuck assembly as claimed in claim 3, wherein the first temperature controller and the second temperature controller are independently and separately formed.

5. The chuck assembly as claimed in claim 2, further comprising:
a first supply line adapted to supply the fluid to the first channel from the first temperature controller; and
a second supply line adapted to supply the fluid to the first supply line from the second temperature controller.

6. The chuck assembly as claimed in claim 1, wherein the chuck further includes a second channel through which a thermoconductive gas is supplied to a back surface of the wafer.

7. The chuck assembly as claimed in claim 2, further comprising a fluid line system including:
a first line in which the fluid is provided to the first channel from the first temperature controller;
a second line in which the fluid is provided to the first temperature controller from the first channel; and
a third line in which the fluid is provided to the first line from the second temperature controller.

8. The chuck assembly as claimed in claim 7, wherein the chuck comprises a second channel through which a thermoconductive gas is supplied to a back surface of the wafer.

9. The chuck assembly as claimed in claim 7, wherein the chuck further comprises a temperature sensor adapted to monitor the temperature thereof.

10. The chuck assembly as claimed in claim 9, further comprising:
a main controller for receiving information on the temperature of the chuck from the temperature sensor so as to control the operation of the temperature control system.

11. The chuck assembly as claimed in claim 7, wherein the fluid is a liquid.

12. The chuck assembly as claimed in claim 11, wherein the liquid is at least one of a water, an ethylene glycol, a silicon oil, a liquid Teflon, a water-glycol mixture, and combinations thereof.

13. The chuck assembly as claimed in claim 1, wherein the chuck includes an electrode cap, where a dielectric film is formed, and an electrode disposed with the electrode cap, and
the temperature control system includes a first temperature control system and a second temperature control system,
the first temperature control system including a first temperature controller configured to maintain the fluid within a first temperature range and supply the fluid maintained within the first temperature range to the first channel, and
the second temperature control system having a plurality of temperature controllers so as to vary the fluid maintained within the first temperature range to a temperature range different than the first temperature range before the fluid is supplied to the first channel.

14. The chuck assembly as claimed in claim 13, further comprising:
a first fluid line system, disposed between the first temperature control system and the chuck, including a first supply line in which the fluid is supplied to the first channel from the first temperature control system and a first recovery line in which the fluid circulating in the first channel is supplied to the first temperature control system from the first channel; and
a second fluid line system, disposed between the first temperature control system and the second temperature control system, including a second supply line in which the fluid is supplied to the first supply from the second temperature control system and a second recovery line in which a part of the fluid circulating in the channel is supplied to the second temperature control system from the first temperature control system.

15. The chuck assembly as claimed in claim 14, wherein the electrode cap comprises a second channel through which a thermoconductive gas is supplied to a back surface of the wafer.

16. The chuck assembly as claimed in claim 14, wherein the electrode cap further comprises a temperature sensor adapted to monitor the temperature of an electrode cap.

17. The chuck assembly as claimed in claim 16, further comprising:
a main controller for receiving information on the temperature of the electrode cap from the temperature sensor so as to control the operation of the temperature control system.

18. The chuck assembly as claimed in claim 14, wherein the fluid is a liquid.

19. The chuck assembly as claimed in claim 18, wherein the liquid is at least one of a water, an ethylene glycol, a silicon oil, a liquid Teflon, a water-glycol mixture, and combinations thereof.

20. A method for controlling a temperature of a chuck, comprising:
setting a temperature of a fluid within a first temperature range;
varying the temperature of the fluid to a second temperature range, which is different from the first temperature range, before the fluid is supplied to a chuck; and
supplying the fluid within the second temperature range to the chuck.

21. The method as claimed in claim 20, further comprising:
varying the fluid to a third temperature range, which is different from the second temperature range, before the fluid is re-supplied to the chuck; and
supplying the fluid within the third temperature range to the chuck.

22. The method as claimed in claim 20, wherein varying the fluid to the second temperature range uses a temperature control system configured to maintain the temperature of the fluid within the first temperature range and vary the fluid maintained within the first temperature range to the second temperature range from the first temperature range.
